(19) United States
(12) Patent Application Publication
(10) Pub. No.: US 2023/0162755 A1
(43) Pub. Date: May 25, 2023

(54) OBJECT LEFT-BEHIND DETECTION METHOD, OBJECT LEFT-BEHIND DETECTION APPARATUS, AND PROGRAM

(71) Applicant: NIPPON TELEGRAPH AND TELEPHONE CORPORATION, Tokyo (JP)

(72) Inventors: Kazunori KOBAYASHI, Tokyo (JP); Shin MURATA, Tokyo (JP)

(73) Assignee: NIPPON TELEGRAPH AND TELEPHONE CORPORATION, Tokyo (JP)

(21) Appl. No.: 17/916,963

(22) PCT Filed: Apr. 8, 2020
(86) PCT No.: PCT/JP2020/015795

§ 371 Date: Oct. 4, 2022

(51) Int. Cl. G10L 25/51; G10L 25/21; G10L 25/18; G10L 25/90; G10L 25/06

(52) U.S. Cl. CPC G10L 25/51; G10L 25/21; G10L 25/18; G10L 25/90; G10L 25/06

(57) ABSTRACT

In order to detect the object left-behind of an infant in an automobile without installing a dedicated sensor, a microphone (M1) installed in the automobile picks up an acoustic signal. An autocorrelation unit (11) determines an autocorrelation function from the acoustic signal. A peak detection unit (12) detects the time of a peak of the autocorrelation value as a pitch period. An inverse calculation unit (13) calculates the inverse of a peak period as a pitch frequency. A pitch determination unit (21) determines whether or not the pitch frequency is included in a predetermined frequency band.

### TECHNICAL FIELD

This invention relates to a technique for detecting the object left-behind of an infant in an automobile.

### BACKGROUND ART

In recent years, many fatal accidents have occurred involving infants abandoned in automobiles. To prevent object left-behind accidents of this type, object left-behind detection techniques using human sensors have been proposed (see NPL 1, for example). In the technique described in NPL 1, the presence or absence of an infant in an automobile is detected using an infrared sensor, a heart rate sensor, or the like, for example. When the existence of an infant is detected while the automobile is stationary, an alarm is sounded, or a user or a call center is notified, for example.

### CITATION LIST

### Non Patent Literature

[NPL 1] Impress Corporation, “Eradicating the object left-behind of infants in cars. Valeo develops dedicated in-car radar that can also be used for adults and pets” [online], retrieved on Mar. 27, 2020, Internet <URL: https://car.watch.impress.co.jp/docs/news/1184711.html>

### SUMMARY OF THE INVENTION

### Technical Problem

However, a sensor that can be used as a human sensor is not usually installed in an automobile, and therefore a dedicated sensor must be newly installed. Introducing a new sensor leads to a cost increase, which becomes a barrier to introduction.

In consideration of the points described above, an object of this invention is to provide a technique with which object left-behind of an infant in an automobile can be detected without installing a dedicated sensor.

### Means for Solving the Problem

To solve the problem described above, an object left-behind detection method according to an aspect of this invention is an object left-behind detection method for detecting the crying voice of an infant from an acoustic signal picked up by a microphone installed in an automobile, the method including having a pitch extraction unit determine a pitch frequency from the acoustic signal, and having a determination unit determine whether or not the pitch frequency is included in a predetermined frequency band.

### Effects of the Invention

According to this invention, a microphone that is typically installed in an automobile for another application is used, and therefore object left-behind of an infant in the automobile can be detected without installing a dedicated sensor.

### BRIEF DESCRIPTION OF DRAWINGS

FIG. 1 is a view showing a functional configuration of an object left-behind detection apparatus according to a first embodiment.

FIG. 2 is a view showing processing procedures of an object left-behind detection method according to the first embodiment.

FIG. 3 is a view illustrating detection of a pitch period.

FIG. 4 is a view showing a functional configuration of an object left-behind detection apparatus according to modified example 1.

FIG. 5 is a view showing a functional configuration of a whitening unit according to modified example 1.

FIG. 6 is a view showing a functional configuration of an object left-behind detection apparatus according to a second embodiment.

FIG. 7 is a view showing a functional configuration of an object left-behind detection apparatus according to a third embodiment.

FIG. 8 is a view showing a functional configuration of an object left-behind detection apparatus according to a fourth embodiment.

FIG. 9 is a view illustrating determination of the shape of a power spectrum.

FIG. 10 is a view showing a functional configuration of a whitening unit according to modified example 2.

FIG. 11 is a view showing a functional configuration of an object left-behind detection apparatus according to a fifth embodiment.

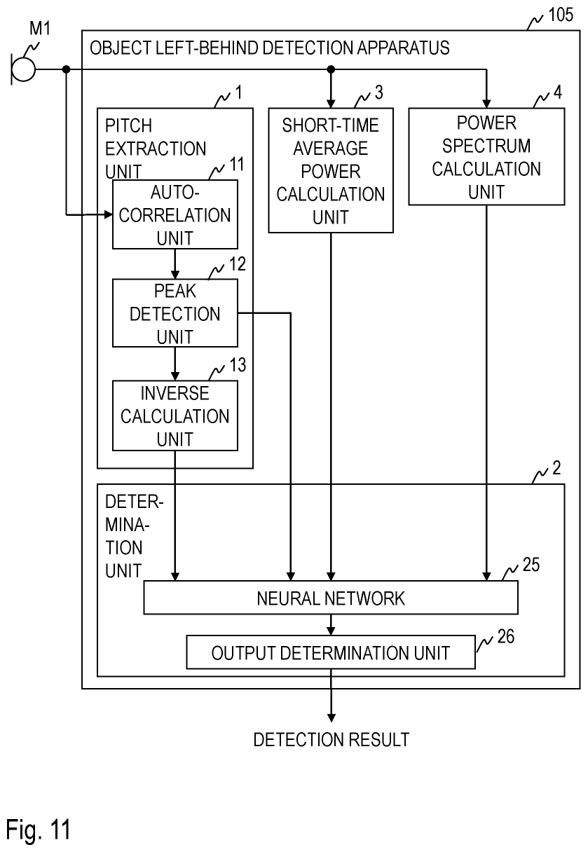

FIG. 12 is a view showing a functional configuration of a computer.

### DESCRIPTION OF EMBODIMENTS

Embodiments of this invention will be described in detail below. Note that configuration parts having identical functions have been allocated identical numerals in the figures, and duplicate description thereof has been omitted.

### First Embodiment

A first embodiment of this invention is an object left-behind detection apparatus and an object left-behind detection method for detecting the object left-behind of an infant in an automobile by detecting the crying voice of the infant from an acoustic signal picked up by a microphone installed in the automobile. Here, use of a microphone that is already installed in the automobile in order to realize another function is envisaged. The other function may be emergency calls, hands-free calls, and so on, for example. Even when a microphone is introduced into an automobile not having any other functions that use a microphone, in-vehicle microphones envisaging these functions are widely available, and therefore newly installing a microphone does not lead to a large cost increase.

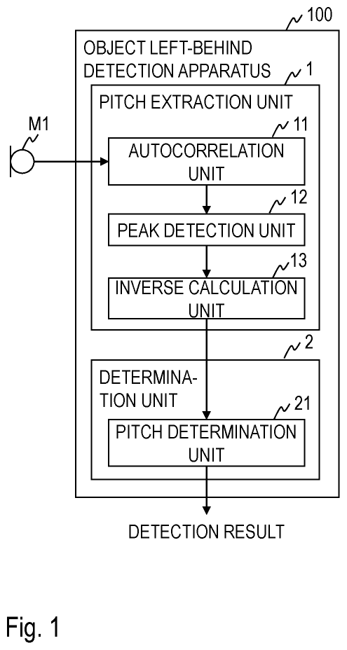

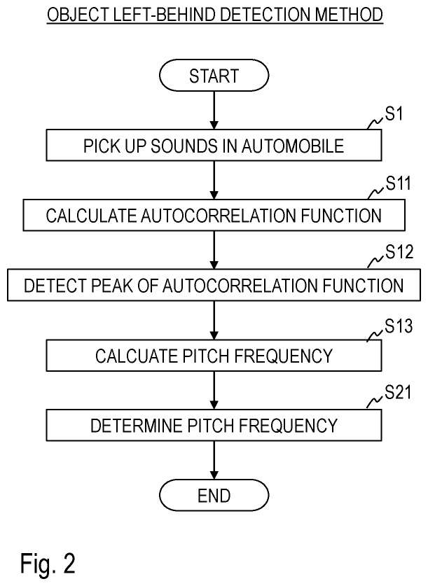

As shown in FIG. 1, an object left-behind detection apparatus 100 according to the first embodiment receives, as input, an acoustic signal picked up by a microphone Ml installed in an automobile to be subjected to object left-behind detection, and outputs a detection result indicating whether or not the acoustic signal includes the crying voice of an infant. The object left-behind detection apparatus 100 includes, for example, a pitch extraction unit 1 and a determination unit 2. The pitch extraction unit 1 includes, for example, an autocorrelation unit 11, a peak detection unit 12, and an inverse calculation unit 13. The determination unit 2 includes, for example, a pitch determination unit 21. By having the object left-behind detection apparatus 100 perform the processing of steps shown in FIG. 2, the object left-behind detection method according to the first embodiment is realized.

The object left-behind detection apparatus 100 is a special apparatus constructed by causing a known or dedicated computer having a central calculation processing device (a Central Processing Unit (CPU)), a main storage device (a Random Access Memory (RAM)), and so on, for example, to read a special program. The object left-behind detection apparatus 100 executes the processing under the control of the central calculation processing device, for example. Data input into the object left-behind detection apparatus 100 and data acquired in the processing are stored in the main storage device, for example, and the data stored in the main storage device are read to the central calculation processing device as required and used for other processing. The object left-behind detection apparatus 100 may be constituted at least partially by hardware such as an integrated circuit.

Referring to FIG. 2, processing procedures of the object left-behind detection method executed by the object left-behind detection apparatus 100 according to the first embodiment will be described.

In step S1, the microphone Ml picks up sound in the automobile and converts the sound into an acoustic signal. The acoustic signal picked up by the microphone Ml is input into the object left-behind detection apparatus 100. The acoustic signal (also referred to hereafter as an “input acoustic signal”) input into the object left-behind detection apparatus 100 is input into the autocorrelation unit 11 of the pitch extraction unit 1.

In step S11, the autocorrelation unit 11 of the pitch extraction unit 1 determines an autocorrelation function from the input acoustic signal. The autocorrelation unit 11 outputs information regarding the determined autocorrelation function to the peak detection unit 12.

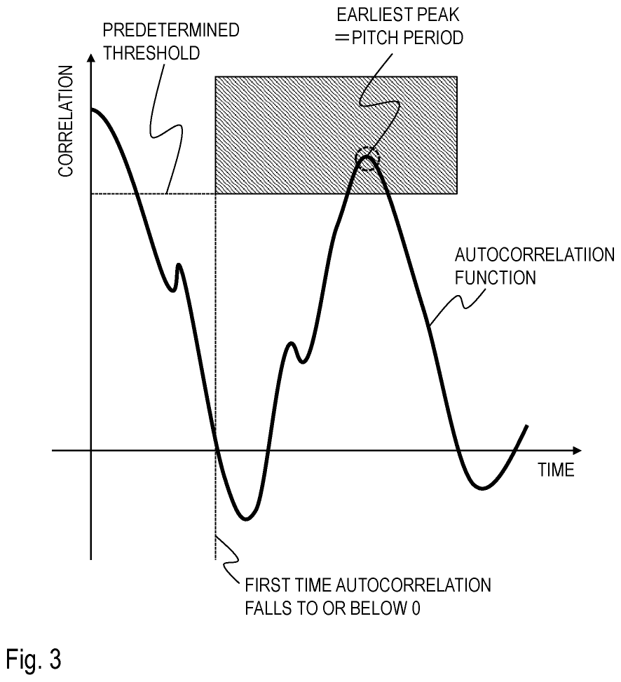

In step S12, the peak detection unit 12 of the pitch extraction unit 1 detects a peak corresponding to a pitch period of the input acoustic signal from the autocorrelation function. More specifically, as shown in FIG. 3, the peak detection unit 12 views values (also referred to hereafter as “autocorrelation values”) of the autocorrelation function in order in a positive direction from a time 0. The peak detection unit 12 then detects the earliest peak within a range that is no earlier than the first time the autocorrelation value falls to or below 0 and that satisfies the condition that the autocorrelation value equals or exceeds a predetermined threshold, and acquires the corresponding time as the pitch period. The peak detection unit 12 outputs the acquired pitch period to the inverse calculation unit 13.

In step S13, the inverse calculation unit 13 of the pitch extraction unit 1 calculates the inverse of the input pitch period and acquires the calculation result as the pitch frequency of the input acoustic signal. The inverse calculation unit 13 outputs the acquired pitch frequency to the pitch determination unit 21 of the determination unit 2.

In step S21, the pitch determination unit 21 of the determination unit 2 determines whether or not the input pitch frequency is included in a predetermined frequency band (also referred to hereafter as a “determination frequency band”). When the pitch frequency is included in the determination frequency band, it is determined that the input acoustic signal includes the crying voice of an infant, and when the pitch frequency is not included in the determination frequency band, it is determined that the input acoustic signal does not include the crying voice of an infant. The determination frequency band is no less than 400 Hz and less than 600 Hz, for example. The pitch frequency of an adult voice is normally approximately 100-300 Hz. Therefore, by setting the determination frequency band as described above, it is possible to detect only the crying voice or the voice of an infant, without responding to adult voices. The pitch determination unit 21 sets the determination result as the output of the object left-behind detection apparatus 100.

### Modified Example 1

In modified example 1, the object left-behind detection apparatus 100 according to the first embodiment is configured such that the crying voice of an infant is detected after whitening the acoustic signal picked up by the microphone Ml.

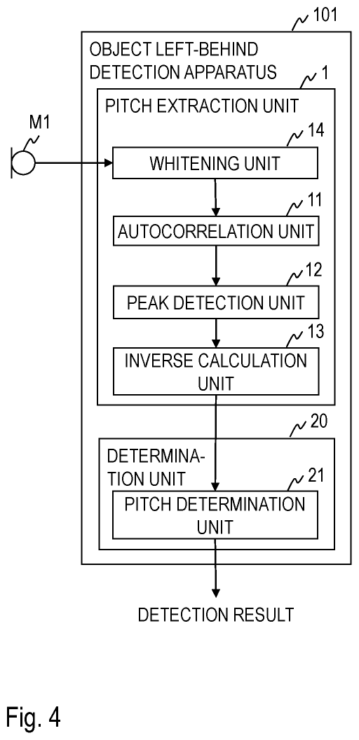

As shown in FIG. 4, an object left-behind detection apparatus 101 according to modified example 1 differs from the object left-behind detection apparatus 100 according to the first embodiment in the following respect. The pitch extraction unit 1 further includes a whitening unit 14. The acoustic signal input into the object left-behind detection apparatus 101 is input into the whitening unit 14. The output of the whitening unit 14 is input into the autocorrelation unit 11.

The whitening unit 14 of the pitch extraction unit 1 whitens a frequency corresponding to a vocal tract characteristic of the input acoustic signal. In other words, the input acoustic signal is processed such that the spectrum envelope becomes white. By performing this processing, only a vocal cord characteristic remains in the input acoustic signal, and therefore the pitch frequency can be determined more accurately. The whitening unit 14 can perform whitening by performing an inverse transform while keeping only high-order coefficients of cepstrum coefficients.

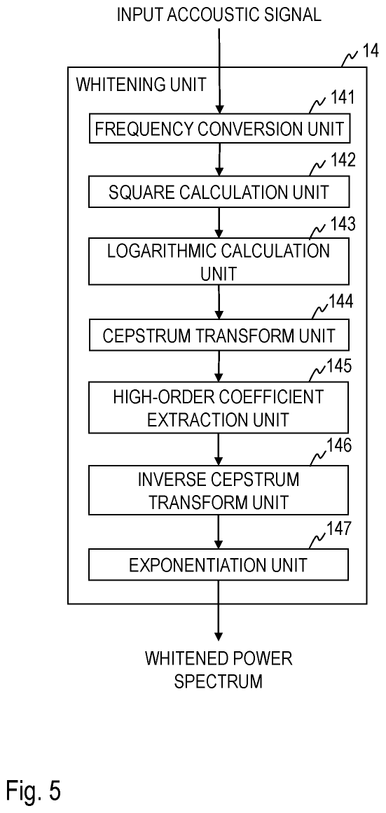

A specific configuration of the whitening unit 14 is shown in FIG. 5. The whitening unit 14 includes a frequency conversion unit 141, a square calculation unit 142, a logarithmic calculation unit 143, a cepstrum transform unit 144, a high-order coefficient extraction unit 145, an inverse cepstrum transform unit 146, and an exponentiation unit 147.

The frequency conversion unit 141 converts the input acoustic signal into the frequency domain over a window length of approximately several tens of milliseconds to several seconds. The square calculation unit 142 acquires a power spectrum by calculating the square of each numerical value of the input acoustic signal in the frequency domain. The logarithmic calculation unit 143 subjects the power spectrum to a logarithmic transform. The cepstrum transform unit 144 acquires a cepstrum by subjecting the logarithmic power spectrum to frequency conversion. The high-order coefficient extraction unit 145 extracts only the high-order coefficients of the cepstrum. For example, when a 16 kHz-sampled input acoustic signal is subjected to frequency conversion over a window length of 1024 samples, cepstrum coefficients of order 10 and higher are extracted as the high-order coefficients. The inverse cepstrum transform unit 146 subjects the high-order coefficients of the cepstrum to inverse frequency transform. The exponentiation unit 147 acquires a power spectrum (also referred to hereafter as a “whitened power spectrum”) in which the spectrum envelope has been whitened by exponentiating the output of the inverse cepstrum transform unit 146. The exponentiation unit 147 outputs the whitened power spectrum to the autocorrelation unit 11.

The autocorrelation unit 11 acquires an autocorrelation function in which the spectrum envelope has been whitened by subjecting the whitened power spectrum to inverse frequency transform.

### Second Embodiment

In the first embodiment, the crying voice of an infant is detected using the pitch frequency of the acoustic signal. In a second embodiment, the crying voice of an infant is detected using an autocorrelation value corresponding to the pitch period in addition to the pitch frequency.

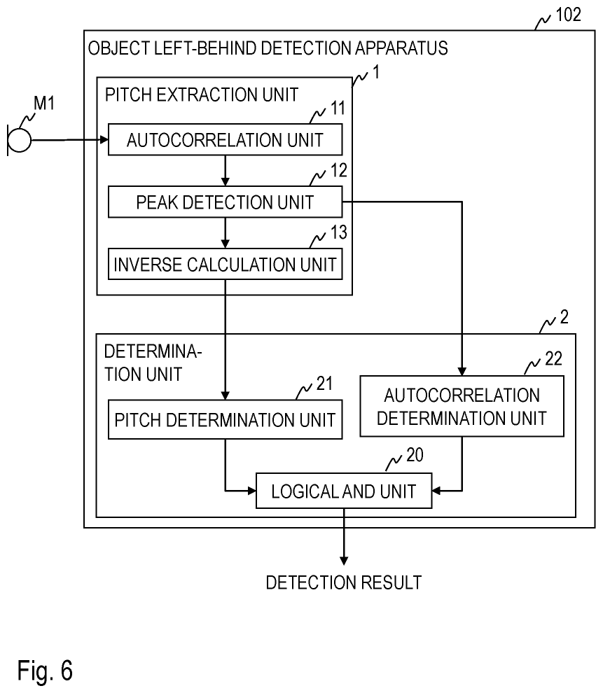

As shown in FIG. 6, an object left-behind detection apparatus 102 according to the second embodiment differs from the object left-behind detection apparatus 100 according to the first embodiment in the following respect. The pitch extraction unit 1 outputs an autocorrelation value corresponding to the pitch period (in other words, an autocorrelation value corresponding to the peak detected by the peak detection unit 12). The determination unit 2 further includes an autocorrelation determination unit 22 and a logical AND unit 20. The autocorrelation value output by the pitch extraction unit 1 is input into the autocorrelation determination unit 22 of the determination unit 2. The outputs of the pitch determination unit 21 and the autocorrelation determination unit 22 are input into the logical AND unit 20. The logical AND unit 20 outputs a detection result. The pitch extraction unit 1 may also include the whitening unit 14.

The autocorrelation determination unit 22 determines whether or not the input autocorrelation value exceeds a predetermined threshold (also referred to hereafter as an “autocorrelation threshold”). When the autocorrelation value exceeds the autocorrelation threshold, the autocorrelation determination unit 22 determines that the input acoustic signal includes the crying voice of an infant, and when the autocorrelation value does not exceed the autocorrelation threshold, the autocorrelation determination unit 22 determines that the input acoustic signal does not include the crying voice of an infant. The autocorrelation threshold is set at approximately 0.7-0.9, for example.

The logical AND unit 20 outputs the logical AND of the determination result output by the pitch determination unit 21 and the determination result output by the autocorrelation determination unit 22 as the detection result. More specifically, when the determination result of the pitch determination unit 21 and the determination result of the autocorrelation determination unit 22 both indicate that the input acoustic signal includes the crying voice of an infant, the logical AND unit 20 outputs a detection result indicating that the input acoustic signal includes the crying voice of an infant.

### Third Embodiment

In the second embodiment, the crying voice of an infant is detected using the pitch frequency of the acoustic signal and an autocorrelation value corresponding to the pitch period. In a third embodiment, the crying voice of an infant is detected also using a short-time average power.

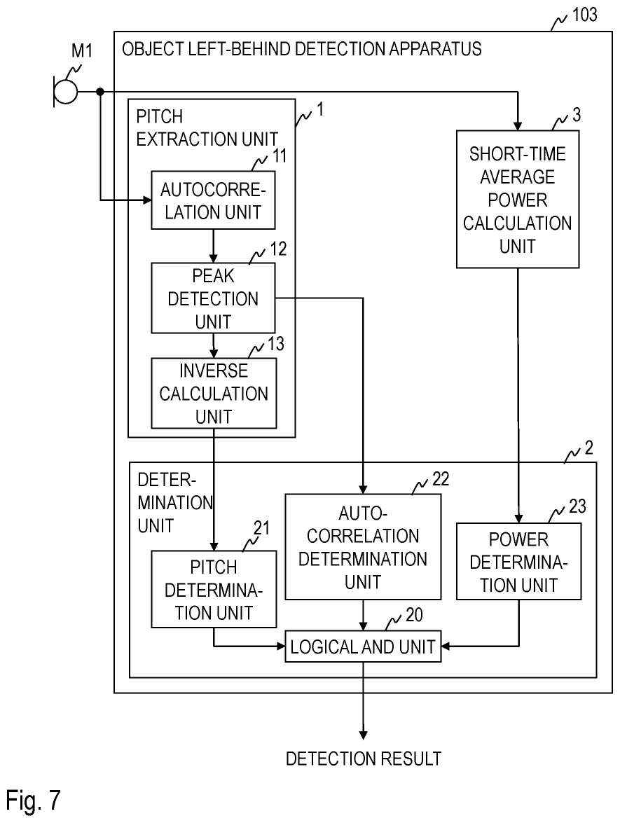

As shown in FIG. 7, an object left-behind detection apparatus 103 according to the third embodiment differs from the object left-behind detection apparatus 102 according to the second embodiment in the following respect. The object left-behind detection apparatus 103 further includes a short-time average power calculation unit 3. The determination unit 2 further includes a power determination unit 23. The acoustic signal input into the object left-behind detection apparatus 103 is also input into the short-time average power calculation unit 3. The output of the short-time average power calculation unit 3 is input into the power determination unit 23 of the determination unit 2. The output of the power determination unit 23 is also input into the logical AND unit 20. The pitch extraction unit 1 may also include the whitening unit 14.

The short-time average power calculation unit 3 calculates the short-time average power of the input acoustic signal. A period in which averaging is performed is set in advance at several hundred milliseconds to several seconds. The short-time average power calculation unit 3 outputs the calculated short-time average power to the power determination unit 23.

The power determination unit 23 determines whether or not the short-time average power input therein exceeds a predetermined threshold (also referred to hereafter as a “power threshold”). The power threshold is set at a value that is sufficiently exceeded by the output of the short-time average power calculation unit 3 when an infant starts crying in a seat. When the short-time average power exceeds the power threshold, the power determination unit 23 determines that the input acoustic signal includes the crying voice of an infant, and when the short-time average power does not exceed the power threshold, the power determination unit 23 determines that the input acoustic signal does not include the crying voice of an infant.

The logical AND unit 20 outputs the logical AND of the determination result output by the pitch determination unit 21, the determination result output by the autocorrelation determination unit 22, and the determination result output by the power determination unit 23 as the detection result. More specifically, when the determination result of the pitch determination unit 21, the determination result of the autocorrelation determination unit 22, and the determination result of the power determination unit 23 all indicate that the input acoustic signal includes the crying voice of an infant, the logical AND unit 20 outputs a detection result indicating that the input acoustic signal includes the crying voice of an infant.

### Fourth Embodiment

In the second embodiment, the crying voice of an infant is detected using the pitch frequency of the acoustic signal and an autocorrelation value corresponding to the pitch period. In a fourth embodiment, the crying voice of an infant is detected also using the power spectrum.

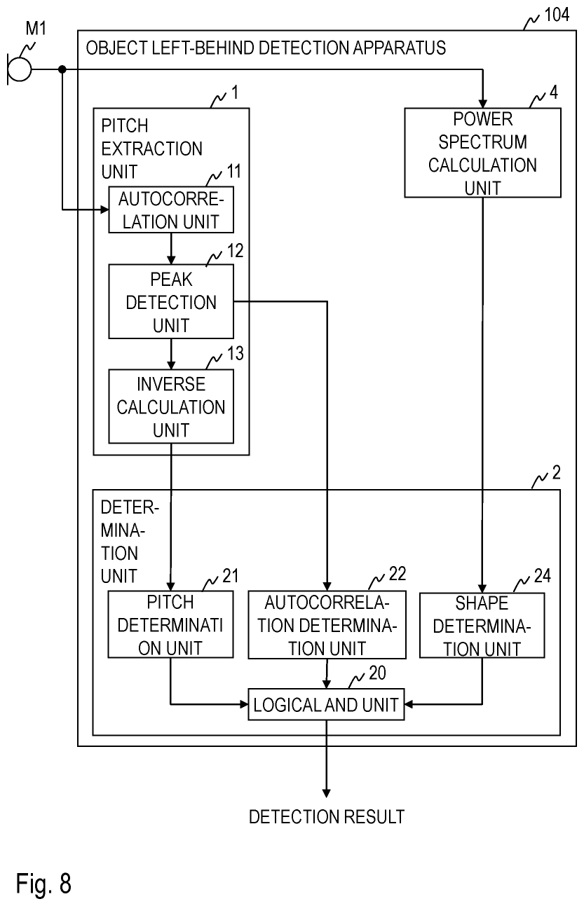

As shown in FIG. 8, an object left-behind detection apparatus 104 according to the fourth embodiment differs from the object left-behind detection apparatus 102 according to the second embodiment in the following respect. The object left-behind detection apparatus 104 further includes a power spectrum calculation unit 4. The determination unit 2 further includes a shape determination unit 24. The acoustic signal input into the object left-behind detection apparatus 104 is also input into the power spectrum calculation unit 4. The output of the power spectrum calculation unit 4 is input into the shape determination unit 24 of the determination unit 2. The output of the shape determination unit 24 is also input into the logical AND unit 20. The pitch extraction unit 1 may also include the whitening unit 14.

The power spectrum calculation unit 4 calculates the power spectrum of the input acoustic signal. The power spectrum calculation unit 4 outputs the calculated power spectrum to the shape determination unit 24.

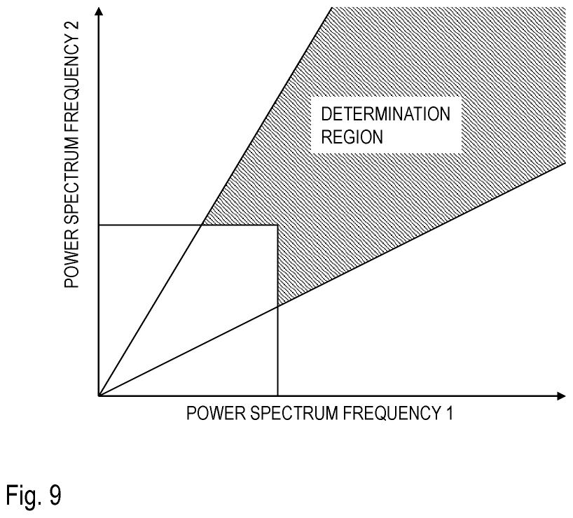

The shape determination unit 24 determines whether or not the power spectrum input therein is included in a predetermined crying voice determination region. When the power spectrum is included in the crying voice determination region, the shape determination unit 24 determines that the input acoustic signal includes the crying voice of an infant, and when the power spectrum is not included in the crying voice determination region, the shape determination unit 24 determines that the input acoustic signal does not include the crying voice of an infant. As shown in FIG. 9, the crying voice determination region is acquired by determining a region that corresponds to the crying voice of an infant in advance from a relationship between two different frequencies included in the power spectrum.

The logical AND unit 20 outputs the logical AND of the determination result output by the pitch determination unit 21, the determination result output by the autocorrelation determination unit 22, and the determination result output by the shape determination unit 24 as the detection result. More specifically, when the determination result of the pitch determination unit 21, the determination result of the autocorrelation determination unit 22, and the determination result of the shape determination unit 24 all indicate that the input acoustic signal includes the crying voice of an infant, the logical AND unit 20 outputs a detection result indicating that the input acoustic signal includes the crying voice of an infant.

### Modified Example 2

The object left-behind detection apparatus 104 according to the fourth embodiment may be configured such that the power spectrum acquired midway through the processing of the pitch extraction unit 1 is used. An object left-behind detection apparatus according to modified example 2 does not include the power spectrum calculation unit 4 and instead includes a whitening unit 15 shown in FIG. 9. The whitening unit 15 of modified example 2 includes a band aggregating unit 148 in addition to the respective processing units of the whitening unit 14 of modified example 1. The band aggregating unit 148 performs band aggregation by averaging the output of the square calculation unit 142 within a preset band and outputs the result to the shape determination unit 24 of the determination unit 2. In other words, the whitening unit 15 is a processing unit having the functions of both the whitening unit 14 and the power spectrum calculation unit 4.

### Modified Example 3

The third embodiment and the fourth embodiment may be combined. More specifically, an object left-behind detection apparatus according to modified example 3 includes the pitch extraction unit 1, the determination unit 2, the short-time average power calculation unit 3, and the power spectrum calculation unit 4. The determination unit 2 of modified example 3 includes the pitch determination unit 21, the autocorrelation determination unit 22, the power determination unit 23, and the shape determination unit 24. The logical AND unit 20 of modified example 3 outputs the logical AND of the determination result output by the pitch determination unit 21, the determination result output by the autocorrelation determination unit 22, the determination result output by the power determination unit 23, and the determination result output by the shape determination unit 24 as the detection result. More specifically, when the determination result of the pitch determination unit 21, the determination result of the autocorrelation determination unit 22, the determination result of the power determination unit 23, and the determination result of the shape determination unit 24 all indicate that the input acoustic signal includes the crying voice of an infant, the logical AND unit 20 of modified example 3 outputs a detection result indicating that the input acoustic signal includes the crying voice of an infant.

### Fifth Embodiment

A fifth embodiment is configured such that some or all of the pitch frequency, the autocorrelation value, the short-time average power, and the power spectrum determined in the first to fourth embodiments are input into a discriminator such as a neural network, and a determination is made from the output value thereof.

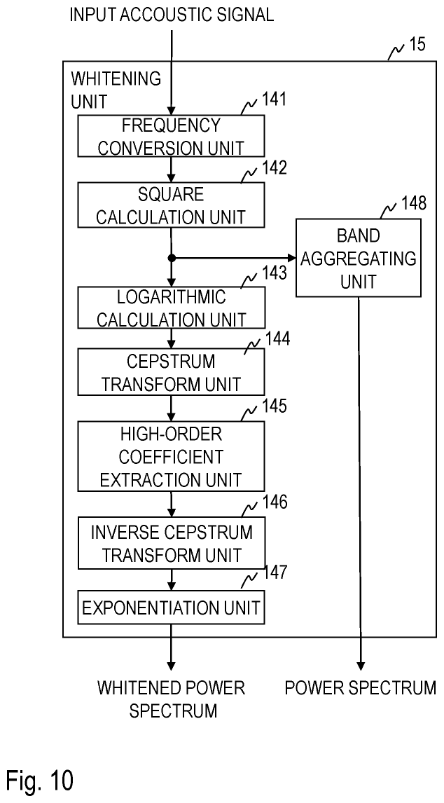

As shown in FIG. 10, in an object left-behind detection apparatus 105 according to the fifth embodiment, the determination unit 2 includes a neural network 25 and an output determination unit 26. The neural network 25 uses some or all of the pitch frequency and the autocorrelation value corresponding to the pitch period, output by the pitch extraction unit 1, the short-time average power output by the short-time average power calculation unit 3, and the power spectrum output by the power spectrum calculation unit 4 (or the pitch extraction unit 1) as input. The output of the neural network 25 is input into the output determination unit 26. Coefficients of the neural network 25 are learned using a known machine learning method and using acoustic signals collected in advance in the automobile as learning data. The output determination unit 26 compares the output value of the neural network 25 with a preset threshold (also referred to hereafter as a “discrimination threshold”). When the output value of the neural network 25 exceeds the discrimination threshold, the output determination unit 26 determines that the input acoustic signal includes the crying voice of an infant, and when the output value does not exceed the discrimination threshold, the output determination unit 26 determines that the input acoustic signal does not include the crying voice of an infant.

In a case where the neural network 25 does not use the autocorrelation value, the pitch extraction unit 1 need not output the autocorrelation value corresponding to the pitch period. Further, in a case where the neural network 25 does not use the short-time average power or the power spectrum, the object left-behind detection apparatus 105 need not include the short-time average power calculation unit 3 or the power spectrum calculation unit 4.

Embodiments of this invention were described above, but specific configurations are not limited to these embodiments, and it goes without saying that appropriate design modifications and so on made within a scope that does not depart from the spirit of the invention are also included in the invention. The various types of processing described in the embodiments are not limited to being executed in time series in the order described, and may be executed in parallel or individually either in accordance with the processing capability of the apparatus that executes the processing or as required.

[Program, Recording Medium]

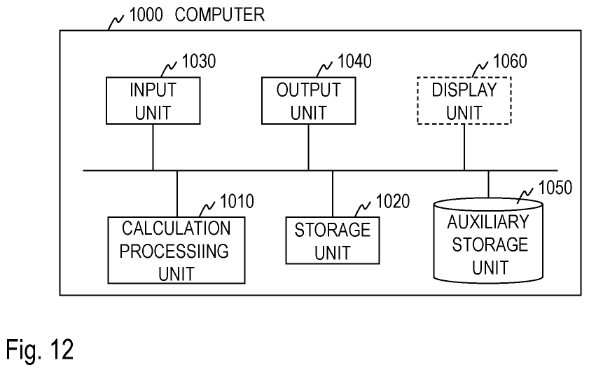

When the various processing functions of the apparatuses described in the above embodiments are realized by a computer, the processing content of the functions to be included in the apparatuses are described by a program. The program is then read to a storage unit 1020 of a computer shown in FIG. 12, and by operating a calculation processing unit 1010, an input unit 1030, an output unit 1040, and so on, the various processing functions of the apparatuses described above are realized on the computer.

The program describing the processing content can be recorded in advance on a computer-readable recording medium. The computer-readable recording medium is a non-temporary recording medium, for example, such as a magnetic recording device or an optical disk.

Further, the program is distributed through the sale, transfer, rental, and so on of a portable recording medium, such as a DVD or a CD-ROM, on which the program is recorded, for example. Furthermore, the program may be stored on a storage device of a server computer, and the program may be distributed by transferring the program from the server computer to another computer over a network.

First, for example, the computer that executes the program stores the program recorded on the portable recording medium or the program transferred from the server computer temporarily in an auxiliary recording unit 1050 serving as a non-temporary storage device provided therein. Then, when executing the processing, the computer reads the program, which is stored in the auxiliary recording unit 1050 serving as a non-temporary storage device provided therein, to the storage unit 1020 serving as a temporary storage device, and executes processing corresponding to the read program. Alternatively, as different embodiments of the program, the computer may read the program directly from the portable recording medium and execute processing corresponding to the program, or the computer may execute processing corresponding to the program received from the server computer each time the program is transferred thereto from the server computer. Furthermore, instead of transferring the program to the computer from a server computer, the processing described above may be executed by a so-called ASP (Application Service Provider) type service, in which a processing function is realized by execution commands and result acquisition alone. Note that the program according to this embodiment is also assumed to include an equivalent to a program in the form of information used for processing by an electronic calculation apparatus (data that are not constituted by a direct command to a computer but have a property of defining computer processing, or the like).

Moreover, in this embodiment, the apparatus is realized by executing a predetermined program on a computer, but at least some of the processing content may be realized by hardware.

1. An object left-behind detection method for detecting the crying voice of an infant from an acoustic signal picked up by a microphone installed in an automobile, the method comprising:
determining, by a pitch extraction circuitry of an object left-behind detection apparatus, a pitch frequency from the acoustic signal; and
determining, by a determination circuitry of the object left-behind detection apparatus, whether or not the pitch frequency is included in a predetermined frequency band.

2. The object left-behind detection method according to claim 1, wherein, in the pitch extraction circuitry,
determining, by an autocorrelation circuitry of the pitch extraction circuitry, an autocorrelation function from the acoustic signal,
detecting, by a peak detection circuitry of the pitch extraction circuitry, as a pitch period, the time of the earliest peak within a range that is no earlier than the first time an autocorrelation value of the autocorrelation function falls to or below 0 and that satisfies a condition according to which the autocorrelation value equals or exceeds a predetermined threshold, and
calculating, by an inverse calculation circuitry of the pitch extraction circuitry, the inverse of the pitch period as the pitch frequency.

3. The object left-behind detection method according to claim 2, further comprising:
determining, by the determination circuitry of the object left-behind detection apparatus, whether or not the autocorrelation value corresponding to the pitch period exceeds a predetermined autocorrelation threshold.

4. The object left-behind detection method according to claim 2, further comprising:
determining, by the determination circuitry of the object left-behind detection apparatus, whether or not a short-time average power calculated from the acoustic signal exceeds a predetermined power threshold.

5. The object left-behind detection method according to claim 2, further comprising:
determining, by the determination circuitry of an object left-behind detection apparatus, whether or not a power spectrum calculated from the acoustic signal is included in a predetermined determination region.

6. An object left-behind detection apparatus for detecting the crying voice of an infant from an acoustic signal picked up by a microphone installed in an automobile, the apparatus comprising processing circuitry configured to:
determine a pitch frequency from the acoustic signal; and
determine whether or not the pitch frequency is included in a predetermined frequency band.

7. A non-transitory computer recording medium on which a program for causing a computer to execute the steps of the object left-behind detection method according to claim 1.

8. The object left-behind detection method according to claim 3 further comprising:
determining, by the determination circuitry of the object left-behind detection apparatus, whether or not a short-time average power calculated from the acoustic signal exceeds a predetermined power threshold.

9. The object left-behind detection method according to claim 3 further comprising:
determining, by the determination circuitry of an object left-behind detection apparatus, whether or not a power spectrum calculated from the acoustic signal is included in a predetermined determination region.

10. A non-transitory computer recording medium on which a program for causing a computer to execute the steps of the object left-behind detection method according to claim 2.

11. A non-transitory computer recording medium on which a program for causing a computer to execute the steps of the object left-behind detection method according to claim 3.

12. A non-transitory computer recording medium on which a program for causing a computer to execute the steps of the object left-behind detection method according to claim 4.

13. A non-transitory computer recording medium on which a program for causing a computer to execute the steps of the object left-behind detection method according to claim 5.
